(19) United States
(12) Patent Application Publication
(10) Pub. No.: US 2017/0222836 A1
(43) Pub. Date: Aug. 3, 2017

(54) DEVICE AND METHOD FOR HANDLING SEQUENCE ESTIMATION

(71) Applicant: MStar Semiconductor, Inc., Hsinchu Hsien (TW)

(72) Inventors: Yi-Ying Liao, Hsinchu Hsien (TW); Tai-Lai Tung, Hsinchu Hsien (TW)

(21) Appl. No.: 15/272,729

(22) Filed: Sep. 22, 2016

(30) Foreign Application Priority Data
Jan. 28, 2016 (TW) 105102644

(51) Int. Cl. H04L 25/03; H04B 1/16

(52) U.S. Cl. CPC H04L 25/03057; H04B 1/16

(57) ABSTRACT

A sequence estimation device includes: a soft decision processing unit, generating a plurality of input signals including soft information according to a plurality of first equalized signals, an equalizer weight and a plurality of estimation signals corresponding to the equalizer weight; and a decoding unit, coupled to the soft decision processing unit, decoding the plurality of input signals including the soft information according to a decoding rule to generate a plurality of output signals.

This application claims the benefit of Taiwan application Serial No. 105102644, filed Jan. 28, 2016, the subject matter of which is incorporated herein by reference.

### BACKGROUND OF THE INVENTION

Field of the Invention

The invention relates in general to a device and method for handling sequence estimation, and more particularly to a device and method for handling sequence estimation according to soft information.

Description of the Related Art

Video broadcasting standards include Advanced Television System Committee (ATSC) in the U.S. Digital Video Broadcasting—Terrestrial (DVB-T) in Europe, Integrated Services Digital Broadcasting—Terrestrial (ISDB-T) in Japan, and Digital Terrestrial Multimedia Broadcast (DTMB) in China. In a digital communication system, a signal could be affected by multipath fading when transmitted via a wireless channel, and inter-symbol interference (ISI) is generated such that a receiver may not correctly recover the signal. To eliminate ISI, a receiver is usually provided with an equalizer and a sequence estimation device to estimate the transmitted signal. Further, to correctly recover the transmitted signal, the receiver is further provided with a decoder to decode an estimation signal to obtain an output signal.

In addition, when a signal is transmitted via a wireless channel, modulation and encoding are performed at the transmitter to avoid signal errors caused by the wireless channel. When the receiver receives the signal, the equalizer and the sequence estimation device in the receiver may obtain an estimation signal including constellation symbols according to hard decision. The estimation signal is a signal including hard information. As the signal including hard information does not contain any information associated with signal errors, the decoder may generate an output signal with a higher error rate. That is to say, the performance of the decoder is degraded, hence affecting a throughput of the communication system.

Therefore, there is a need for how to process an estimation signal to improve the performance of a decoder.

### SUMMARY OF THE INVENTION

The invention is directed to a device and method for handling sequence estimation to solve the above issues.

The present invention discloses a sequence estimation device. The sequence estimation device includes: a soft decision processing unit, r generating a plurality of input signals including soft information according to a plurality of first equalized signals, an equalizer weight and a plurality of estimation signals corresponding to the equalizer weight; and a decoding unit, coupled to the soft decision processing unit, decoding the plurality of input signals including the soft information according to a decoding rule to generate a plurality of output signals.

The present invention further discloses a method for handing sequence estimation. The method includes: generating a plurality of input signals including soft information according to a plurality of first equalized signals, an equalizer weight and a plurality of estimation signals corresponding to the equalizer weight by a soft decision processing unit; and decoding the plurality of input signals including the soft information according to a decoding rule by a decoding unit to generate a plurality of output signals.

The above and other aspects of the invention will become better understood with regard to the following detailed description of the but non-limiting embodiments. The following description is made with reference to the accompanying drawings.

### BRIEF DESCRIPTION OF THE DRAWINGS

FIG. 1 is a schematic diagram of a communication system according to an embodiment of the present invention;

FIG. 2 is a schematic diagram of a sequence estimation device according to an embodiment of the present invention;

FIG. 3 is a schematic diagram of a soft decision processing unit according to an embodiment of the present invention;

FIG. 4 is a schematic diagram of decoding unit according to an embodiment of the present invention; and

FIG. 5 is a flowchart of a process according to an embodiment of the present invention.

### DETAILED DESCRIPTION OF THE INVENTION

Because an estimation signal including hard information reduces the performance of a low-density parity-check (LDPC) decoder, the present invention provides to a sequence estimation device and method for processing such estimation signal including hard information to generate an estimation signal including soft information to further solve the above issues. Details of the implementation of the sequence estimation device and method are described below.

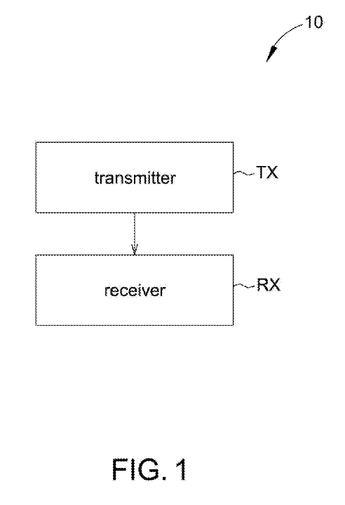

FIG. 1 shows a block diagram of a communication system 10 according to an embodiment of the present invention. The communication system 100 may be any communication system based on single-carrier technologies or orthogonal frequency division multiplexing (OFDM) technologies, and is primarily formed by a transmitter TX and a receiver RX. In FIG. 1, the transmitter TX and the receiver RX are for explaining the architecture of the communication system 10. For example, the communication system 10 may be a wired communication system such as an asymmetric digital subscriber line (ADSL) system or a power line communication (PLC) system, or a wireless communication system such as a wireless local area network (WLAN), a Digital Terrestrial Multimedia Broadcast (DTMB) system or a Long Term Evolution-Advanced (LTE-A) system. Further, for example but not limited to, the transmitter TX and the receiver RX can be disposed in a mobile phone, a laptop computer, a tablet computer, an e-book or a portable computer system.

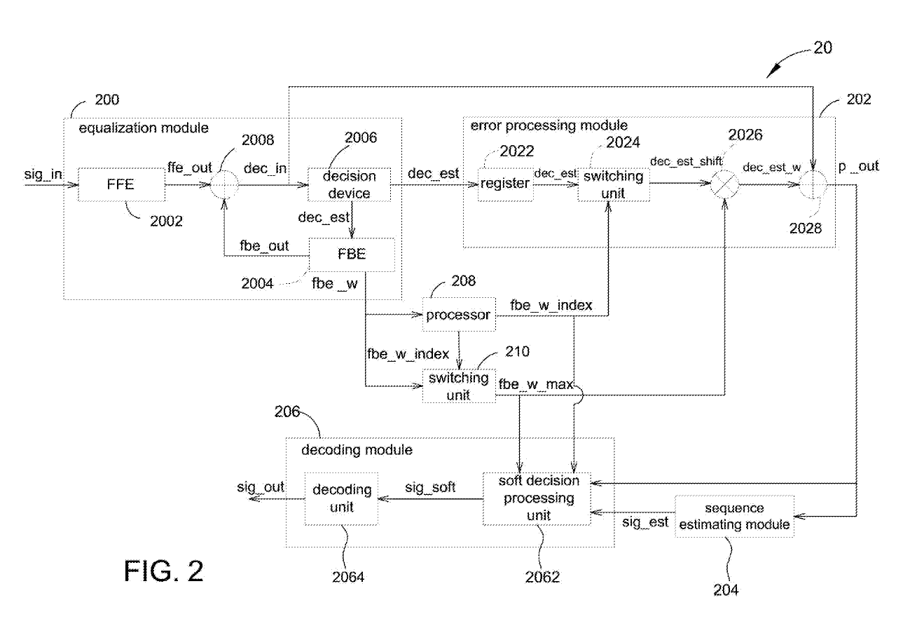

FIG. 2 shows a schematic diagram of a sequence estimation device 20 according to an embodiment of the present invention. The sequence estimation device 20 is used in the receiver RX in FIG. 1 to estimate and decode signals. The sequence estimation device 20 includes an equalization module 200, an error processing unit 202, a sequence estimating module 204, a decoding module 206, a processor 208 and a switching unit 210. The decoding module 206 includes a soft decision processing unit 2062 and a decoding unit 2064. More specifically, the soft decision processing unit 2062 may receive a plurality of estimation signals sig_est, and generate a plurality of input signals sig_soft including soft information according to a plurality of equalized signals p_out, an equalizer weight and a plurality of estimation signals corresponding to the equalizer weight. The decoding unit 2064, coupled to the soft decision processing unit 2062, decodes the plurality of input signals sig_soft including soft information according to a decoding rule (e.g., an LDPC error correction code) to generate a plurality of output signals sig_out. That is to say, before the plurality of estimation signals sig_est are provided to the decoding unit 2064, the soft decision processing unit 2062 may process the plurality of estimation signals sig_est in a way that the plurality of estimation signals sig_est includes soft information, so as to enhance the performance of the decoding unit 2064 to further increase the accuracy of the plurality of output signals sig_out. In short, as the plurality of input signals sig_soft including soft information provide distance information of the plurality of estimation signals sig_est and decision borders, the decoding unit 2064 is capable of more effectively recovering the estimation signal to increase the throughput of the communication system.

The sequence estimating module 204, coupled to the soft decision processing unit 2062, generates the plurality of estimation signals sig_est. More specifically, the sequence estimating module 204 receives the plurality of equalized signals p_out, and sorts the plurality of equalized signals p_out into the plurality of estimation signals sig_est according to a grouping rule and a sequence estimating rule. The sequence estimating rule applied in the sequence estimating module 204 may be a maximum-likelihood sequence estimation (MLSE) rule. Further, there are numerous approaches for realizing the MLSE rule. For example, the sequence estimating module 204 may perform a Viterbi algorithm to realize the MLSE rule when processing the plurality of equalized signals p_out to obtain the plurality of estimation signals sig_est.

The error processing unit 202, coupled to the sequence estimating module 204, receives a plurality of decision signals dec_est, a feedback equalizer weight with a largest absolute value strength fbe_w_max and its index fbe_w_index, and a plurality of equalized signals dec_in, and generates the plurality of equalized signals p_out according to the plurality of decision signals dec_est and the plurality of equalized signals dec_in. More specifically, the error processing unit 202 includes a register 2022, a switching unit 2024, a multiplier 2026 and an adder 2028. The register 2022, coupled to a decision device 2006, receives the plurality of decision signals dec_est, and buffers the plurality of decision signals dec_est according to a predetermined buffering rule (e.g., a queue structure). The switching unit 2024, coupled to the register 2022, generates a plurality of corresponding decision signals dec_est_shift according to the plurality of decision signals dec_est and the index of the feedback equalizer weight with a largest absolute value strength fbe_w_index. The multiplier 2026, coupled to the switching unit 2024, generates a plurality of corresponding weighted decision signals dec_est_w according to the plurality of corresponding decision signals dec_est_shift and the feedback equalizer weight with a largest absolute value strength fbe_w_max. The adder 2028, coupled to the multiplier 2026, generates the plurality of equalized signals p_out according to the plurality of equalized signals dec_in and the plurality of corresponding weighted decision signals dec_est_w.

The processor 208, coupled to a feedback equalizer 2004, receives a plurality of feedback equalizer weights fbe_w, and generates the index of the feedback equalizer weight with the largest absolute value strength fbe_w_index according to a predetermined processing rule. The switching unit 210, coupled to the feedback equalizer 2004 and the processor 208, generates the feedback equalizer weight with the largest absolute value strength fbe_w max according to the plurality of feedback equalizer weights fbe_w and the index of the feedback equalizer weight with the largest absolute value strength fbe_w_index.

The equalization module 200, coupled to the error processing unit 202, receives the plurality of signals sig_in, equalizes the plurality of signals sig_in into the plurality of decision signals dec_est, and generates the plurality of equalized signals dec_in. For example but not limited to, the plurality of signals sig_in may be generated according to quadrature phase-shift keying (QPSK),16 quadrature amplitude modulation (16QAM), 32QAM or other modulation methods. More specifically, the equalization module 200 includes a feedforward equalizer (FFE) 2002, the feedback equalizer (FBE) 2004, the decision device 2006 and an adder 2008. The feedforward equalizer 2002 and the feedback equalizer 2004 respectively include a plurality of feedforward equalizer weights and a plurality of feedback equalizer weights fbe_w for equalizing input signals. That is to say, the feedforward equalizer 2002 may generate a plurality of feedforward weighted signals ffe_out according to the plurality of signals sig_in (e.g., baseband reception signals) and a plurality of feedforward equalizer weights. The feedback equalizer 2004, coupled to the decision device 2006, generates a plurality of feedback weighted signals fbe_out according to the plurality of decision signals dec_est and the plurality of feedback equalizer weights fbe_w. The adder 2008, coupled to the feedforward equalizer 2002 and the feedback equalizer 2004, generates the plurality of equalized signals dec_in according to the plurality of feedforward weighted signals ffe_out and the plurality of feedback weighted signals fbe_out (e.g., dec_in=ffe_out+fbe_out). The decision device 2006, coupled to the adder 2008, generates the plurality of decision signals dec_est according to the plurality of equalized signals dec_in (e.g., through demodulation).

Based on the above description, an embodiment is further provided below to explain the relationship between the signals and the weights. According to a plurality of signals yₙ (e.g., sig_in in FIG. 2), the equalization module 200 first generates a plurality of equalized signals zₙ (e.g., dec_in in FIG. 2), a plurality of decision signals \hat{x}ₙ (e.g., dec_est in FIG. 2), and a plurality of feedback equalizer weights b₁, b₂ . . . , bₕ₋₁ and bₕ (e.g., fbe_w in FIG. 2), where h is the tap. The processor 208 generates an index of the feedback equalizer weight with the largest absolute value strength k (e.g., fbe_w index in FIG. 2) according to the plurality of feedback equalizer weights b₁, b₂. . . , bₕ₋₁ and b. The switching unit 210 generates a feedback equalizer weight with the largest absolute value strength bₖ (e.g., fbe_w_max in FIG. 2) according to the plurality of feedback equalizer weights b₁, b₂ . . . , bₕ₋₁ and bₕ and the index of the feedback equalizer weight with the largest absolute value strength k. To alleviate the issue of error propagation that the equalization module 200 may generate, the error processing unit 202 may generate a plurality of equalized signals rₙ (e.g., p_out in FIG. 2) according to the plurality of decision signals \hat{x}ₙ, the feedback equalizer weight with the largest absolute value strength bₖ and its index k, and the plurality of equalized signals zₙ. There are numerous ways for generating the plurality of equalized signals rₙ; for example but not limited to, according to an equation rₙ=zₙ−bₖ\hat{x}ₙ₋ₖ.

There are numerous ways for implementing the decoding module 206. For example, the soft decision processing unit 2062 may generate the plurality of input signals including soft information sig_soft according to an equation rₙ+bₖ\tilde{x}ₙ₋ₖ, which is corresponding to the equation that the error processing unit 202 uses to generate rₙ, where rₙ is the plurality of equalized signals p_out, \tilde{x}ₙ is the plurality of estimation signals sig_est, bₖ is the feedback equalizer weight with the largest absolute value strength among the plurality of feedback equalized weights, and k is the index of the feedback equalizer weight with the largest absolute value strength, and n is a time index. That is to say, as the plurality of equalized signals p_out includes soft information, the soft decision processing unit 2062 may compute the plurality of equalized signals p_out and the plurality of estimation signals sig_est to obtain the plurality of input signals sig_soft including soft information.

When the plurality of signals sig_in are generated according to QPSK modulation, the decoding accuracy is reduced if the decoding unit 2064 perfomrs a decoding process according to the plurality of estimation signals sig_est. That is to say, the throughput of the communication system is lowered if the decoding unit 2064 cannot efficiently recover the estimation signals. Thus, when the plurality of signals sig_in are generated according to QPSK modulation, these signals sig_in need to be processed by the soft decision processing unit 2062 to include soft information in these signals sig_in, so as to increase the decoding accuracy of the decoding unit 2064. That is to say, in one embodiment, the soft decision processing unit 2062 could be applicable only where the plurality of signals sig_in are generated according to QPSK modulation. In other words, when the plurality of signals sig_in are generated according to 16QAM, 32QAM or other modulation methods, the plurality of estimation signals sig_est may be directly outputted to the decoding unit 2064 for decoding without having to undergo the process of the soft decision processing unit 2062.

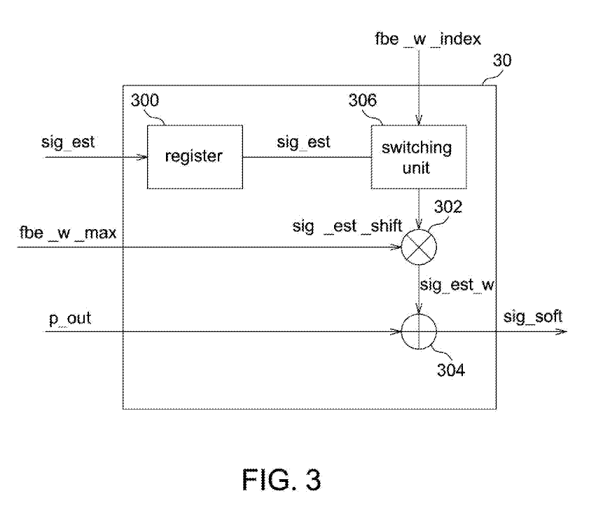

FIG. 3 shows a schematic diagram of a soft decision processing unit 30 according to an embodiment of the present invention. The soft decision processing unit 30 mayrealize the soft decision processing unit 2026 in FIG. 2. The soft decision processing unit 30 can include a register 300, a multiplier 302, an adder 304 and a switching unit 306. The register 300 receives a plurality of estimation signals \tilde{x}ₙ (e.g., sig_est in FIG. 3), and buffers the plurality of estimation signals \tilde{x}ₙ according to a predetermined buffering rule (e.g., a queue structure). The switching unit 306, coupled to the register 300, according to the plurality of estimation signals \tilde{x}ₙ and an index of the largest feedback equalizer weight having a largest absolute value strength k (e.g., fbe_w_index in FIG. 3), generates a plurality of estimation signals \tilde{x}ₙ₋ₖ corresponding to the index k (e.g., sig_est_shift in FIG. 3). According to a feedback equalizer weight bₖ having the largest absolute value strength and the plurality of estimation signals \tilde{x}ₙ₋ₖ corresponding to the index k (e.g., fbe_w_max in FIG. 3), the multiplier 302 may generate a plurality of corresponding weighted estimation signals bₖ\tilde{x}ₙ₋ₖ (e.g., sig_est_w in FIG. 3). The adder 304 may then generate a plurality of input signals including soft information rₙ+bₖ\tilde{x}ₙ₋ₖ (e.g., sig_soft in FIG. 3) according to the plurality of equalized signals rₙ and the plurality of corresponding weighted estimation signals bₖ\tilde{x}ₙ₋ₖ.

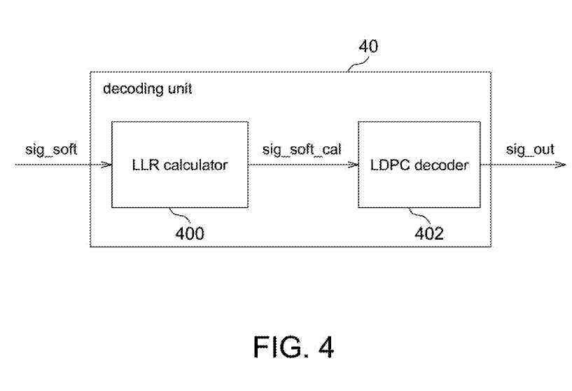

FIG. 4 shows a schematic diagram of a decoding unit 40 according to an embodiment of the present invention. The decoding unit 40 may realize the decoding unit 2064 in FIG. 2. The decoding unit 40 includes a log-likelihood ratio (LLR) calculator 400 and a LDPC decoder 402. The LLR calculator 400 receives a plurality of input signals including soft information sig_soft to generate an LLR signal including soft information sig_soft_cal. Next, the LDPC decoder 402, coupled to the LLR calculator 400, receives the LLR signal including soft information sig_soft_cal to generate a plurality of output signals sig_out. Thus, the decoding unit 40 is capable of enhancing the accuracy of the plurality of output signals sig_out according to the soft information to further increase the throughput of the communication system.

Therefore, through the soft decision processing unit 2062 and the decoding unit 2064 in the decoding module 206, the decoding module 206 is capable of enhancing the performance of the decoder according to the soft information to further increase the throughput of the communication system.

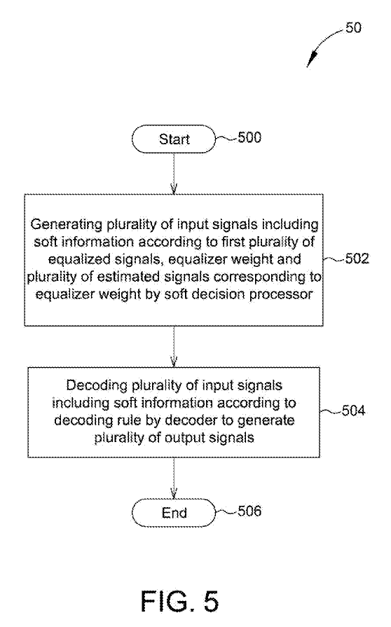

The operations of the decoding module 206 may be further concluded into a process 50, as shown in FIG. 5. The process 50 includes the following steps.

In step 500, the process 50 begins.

In step 502, by a soft decision processing unit, a plurality of input signals including soft information are generated according to a plurality of first equalized signals, an equalizer weight and a plurality of estimation signals corresponding to the equalizer weight.

In step 504, by a decoding unit, the plurality of input signals including soft information are decoded according to a decoding rule to generate a plurality of output signals.

In step 506, the process 50 ends.

In the process 50, the decoding module 206 may use a soft decision processing unit to generate a plurality of input signals including soft information according to a plurality of first equalized signals, an equalizer weight and a plurality of estimation signals corresponding to the equalizer weight. Next, the decoding module 206 may use a decoding unit to decode the plurality of input signals including soft information according to a decoding rule to generate a plurality of output signals.

The process 50 is for illustrating the operations of the decoding module 206. Associated details and variations may be referred from the foregoing description, and shall be omitted herein.

In conclusion, the present invention provides a sequence estimation device and method for estimating and decoding signals. The sequence estimation device includes a decoding module, and is capable of increasing the throughput of a communication system through a soft decision processing unit and a decoding unit in the decoding module.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A sequence estimation device, comprising:
a soft decision processing unit, generating a plurality of input signals comprising soft information according to a plurality of first equalized signals, an equalizer weight and a plurality of estimation signals corresponding to the equalizer weight; and
a decoding unit, coupled to the soft decision processing unit, decoding the plurality of input signals comprising the soft information according to a decoding rule to generate a plurality of output signals.

2. The sequence estimation device according to claim 1, wherein the plurality of input signals comprising the soft information are determined according to an equation:
rₙ+bₖ\tilde{x}ₙ₋ₖ;
wherein, rₙ is the plurality of first equalized signals, \tilde{x}ₙ is the plurality of estimation signals, bₖ is a feedback equalizer weight with a largest strength among a plurality of feedback equalizer weights, k is a corresponding index, and n is a time index.

3. The sequence estimation device according to claim 1, wherein the decoding unit comprises a log-likelihood ratio (LLR) calculator and a low-density parity-check (LDPC) decoder.

4. The sequence estimation device according to claim 1, further comprising:
a sequence estimating module, coupled to the soft decision processing unit, generating the plurality of estimation signals.

5. The sequence estimation device according to claim 4, wherein the sequence estimating module sorts the plurality of first equalized signals to the plurality of estimation signals according to a grouping rule and a sequence estimating rule.

6. The sequence estimation device according to claim 5, further comprising:
an error processing unit, coupled to the sequence estimating module, generating the plurality of first equalized signals according to a plurality of decision signals and a plurality of second equalized signals; and
an equalization module, coupled to the error processing unit, equalizing a plurality of signals to the plurality of decision signals, and generating the plurality of second equalized signals.

7. The sequence estimation device according to claim 6, wherein the plurality of signals are generated according to quadrature phase-shift keying (QPSK), 16 quadrature amplitude modulation (16QAM) or 32QAM.

8. The sequence estimation device according to claim 5, wherein the sequence estimating rule is a maximum-likelihood sequence estimation (MLSE) rule.

9. A method for handling sequence estimation, comprising:
generating a plurality of input signals comprising soft information according to a plurality of first equalized signals, an equalizer weight and a plurality of estimation signals corresponding to the equalizer weight by a soft decision processing unit; and
decoding the plurality of input signals comprising the soft information according to a decoding rule by a decoding unit to generate a plurality of output signals.

10. The method according to claim 9, wherein the plurality of input signals comprising the soft information are determined according to an equation:
rₙ+bₖ\tilde{x}ₙ₋ₖ;
wherein, rₙ is the plurality of first equalized signals, \tilde{x}ₙ is the plurality of estimation signals, bₖ is a feedback equalizer weight with a largest strength among a plurality of feedback equalizer weights, k is a corresponding index, and n is a time index.

11. The method according to claim 9, further comprising:
generating the plurality of estimation signals by a sequence estimating module.

12. The method according to claim 11, further comprising:
sorting the plurality of first equalized signals to the plurality of estimation signals according to a grouping rule and a sequence estimating rule by the sequence estimating module.

13. The method according to claim 12, further comprising:
generating the plurality of first equalized signals according to a plurality of decision signals and a plurality of second equalized signals by an error processing unit; and
equalizing a plurality of signals to the plurality of decision signals, and generating the plurality of second equalized signals by an equalization module.

14. The method according to claim 13, wherein the plurality of signals are generated according to quadrature phase-shift keying (QPSK), 16 quadrature amplitude modulation (16QAM) or 32QAM.

15. The method according to claim 12, wherein the sequence estimating rule is a maximum-likelihood sequence estimation (MLSE) rule.
